(19) United States
(12) Patent Application Publication
(10) Pub. No.: US 2026/0268879 A1
(43) Pub. Date: Sep. 10, 2026

(54) MULTIFUNCTIONAL XYLOPHONE/ELECTRIC PIANO CANTILEVER CART

(71) Applicant: Mark C. Pyle, Peoria, AZ (US)

(72) Inventor: Mark C. Pyle, Peoria, AZ (US)

(21) Appl. No.: 19/395,191

(22) Filed: Nov. 20, 2025

Related U.S. Application Data
(60) Provisional application No. 63/767,621, filed on Mar. 6, 2025.

(51) Int. Cl. G10G 5/00; F16M 11/26; F16M 11/42

(52) U.S. Cl. CPC G10G 5/005; F16M 11/26; F16M 11/42

(57) ABSTRACT

A multifunctional xylophone/electronic piano cantilever cart including improvements for securely holding xylophones, metallophones, and electronic keyboard instruments. The cantilever cart includes a shelf support comprised of spaced horizontal metal rods supported by a pair of legs and feet, and a cantilever shelf releasably secured to the shelf support by a pair of inverted hooks attached to an edge of the shelf. A sheet music holder may be attached to the top of the shelf support, and a stationary shelf may be attached to the bottom of the cantilever cart.

### CROSS-REFERENCE TO RELATED APPLICATION

The present application is related to and claims priority from prior provisional application Ser. No. 63/767,621, filed Mar. 6, 2025 which is incorporated herein by reference.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever. 37 CFR 1.71(d).

### BACKGROUND OF THE INVENTION

### 1. Field of the Invention

This invention relates generally to carts, and more specifically to carts for musical instruments.

### 2. Description of the Related Art

With prior art carts a music teacher has very little time in between class periods to adjust the height of each cart to match age groups. Even within one age group it is necessary to adjust the height of an instrument from one child to the next. With prior art carts, they usually do not get adjusted, and the result is a bad tone from the instrument and even damage can occur from not striking the instrument at the appropriate angle due to incorrect height of the instrument. Prior art carts do not have a tilting capability. Wheelchair bound students are burdened with the task of reaching out beyond what is comfortable on all other instrument carts. Teachers are burdened with the problem of not having enough space in their classrooms. With the advent of technology, band directors have a plethora of electronic devices that aid them in teaching or conducting a band, and it is difficult to have access to all of this equipment while at the conductor's podium. Prior art instrument carts do not have an area for related equipment. Prior art xylophone carts do not have an integrated sheet music holder on them. And many prior art instrument carts have a high center of gravity that exists with taller bass instruments. Thus, a need exists for an improved cart to avoid the above-mentioned problems.

### BRIEF SUMMARY OF THE INVENTION

In view of the foregoing disadvantages inherent in the known types of carts or the like in the prior art, the present invention provides a novel multifunctional xylophone/electronic piano cantilever cart. As such, the general purpose of the present invention, which will be described subsequently in greater detail, is to provide a multifunctional xylophone/electronic piano cantilever cart that includes a shelf support comprised of spaced horizontal metal rods supported by a pair of legs and feet, and a releasably secured to the shelf support by a pair of inverted hooks attached to an edge of the shelf. A sheet music holder may be attached to the top of the shelf support, and a stationary shelf may be attached to the bottom of the cantilever cart, with all the advantages of the prior art and none of the disadvantages.

There has thus been outlined, rather broadly, the more important features of the invention in order that the detailed description thereof that follows may be better understood and in order that the present contribution to the art may be better appreciated. The features of the invention which are believed to be novel are particularly pointed out and distinctly claimed in the concluding portion of the specification. These and other features, aspects, and advantages of the present invention will become better understood with reference to the following drawings and detailed description.

### BRIEF DESCRIPTION OF THE DRAWINGS

The figures which accompany the written portion of this specification illustrate embodiments and method(s) of use for the present invention, a multifunctional xylophone/electronic piano cantilever cart, constructed and operative according to the teachings of the present invention.

FIG. 1 shows a front perspective view illustrating the multifunctional xylophone/electronic piano cantilever cart according to the preferred embodiment of the present invention.

FIG. 2 shows a side view illustrating the multifunctional xylophone/electronic piano cantilever cart according to the preferred embodiment of the present invention of FIG. 1.

FIG. 3 shows another perspective view illustrating the multifunctional xylophone/electronic piano cantilever cart according to the preferred embodiment of the present invention of FIG. 1.

FIG. 4 shows another perspective view illustrating the multifunctional xylophone/electronic piano cantilever cart including multiple supports and shelves according to the preferred embodiment of the present invention of FIG. 1.

FIG. 5 shows a perspective view illustrating one of the pair of inverted hooks of a cantilever shelf engaged with two adjacent horizontal metal rods of the shelf support and holding the cantilever shelf in a relatively horizontal orientation according to the preferred embodiment of the present invention of FIG. 1.

FIG. 6 shows another perspective view illustrating the pair of inverted hooks of a cantilever shelf engaged with one horizontal metal rod of the shelf support holding the cantilever shelf in a vertical orientation according to the preferred embodiment of the present invention of FIG. 1.

FIG. 7 shows side view illustrating one cantilever shelf ready for engagement with the shelf support, and one cantilever shelf engaged with the shelf support in a vertical orientation according to the preferred embodiment of the present invention of FIG. 1.

The various embodiments of the present invention will hereinafter be described in conjunction with the appended drawings.

### DETAILED DESCRIPTION

As discussed above, embodiments of the present invention relate to a multifunctional xylophone/electronic piano cantilever cart.

Advantages of the instant multifunctional xylophone/electronic piano cantilever cart include:
Function #1: Using a novel quick release and re-connect cantilever shelf, a musician is able to raise and lower a xylophone or electronic piano very quickly and efficiently without the use of telescopic legs, wing bolts or snap buttons commonly found on all other instrument carts.
Function #2: In addition to height adjustments, the cantilever shelf can be tilted up or down via a tilt adjustment bolt to position the playing surface of the instrument at an angle preferred by the performer. The tilt adjustment bolt also allows the shelf to hang in a vertical position, which allows carts to be nested together when not in use.
Function #3: The cantilever shelf design also allows wheelchair bound musicians the ability to position themselves closer to the playing surface of the instrument providing greater ease in playing and overall personal comfort.
Function #4: The instrument carts can be stacked one upon the other in order to form a mobile storage rack. With the addition of more shelves, the teacher/musician can store a large number of instruments which take up less space in the classroom.
Function #5: With the cart's shelf support in its highest position, an electronic piano can be used by a Band Director while conducting from an elevated podium. In this position the teacher now has added space for a plethora of devices and teaching aids.
Function #6: A stationary shelf placed at the bottom of the cart can hold very heavy amplifiers, speakers and power packs that are needed in the regular course of a musical performance. The stationary shelf also has 2 slots cut into the shelf that fit around the legs of the cart which gives the legs more stability when the shelf support is in its highest position.
Function #7: The cart is also fitted with a height and tilting adjustable sheet music holder that telescopes into the top of the shelf support.
Function #8: Another function of the cart is the ability to lower the center of gravity on a very tall xylophone in order to prevent tipping the cart which is a common problem with other carts.
Function #9: A non-slip hook and loop (Velcro) carpet covers the top of each shelf to prevent instruments from slipping off the cart.
Function #10: The instrument shelf support may include two holes at the top thereof to hold a pair of mallets commonly used in a performance.

Problem and solution explanation of each of the carts functions:
Function #1: A music teacher has very little time in between class periods to adjust the height of each cart to match the age group. Even within one age group it is necessary to adjust the height of an instrument from one child to the next. With other carts, they usually do not get adjusted, and the result is a bad tone from the instrument and even damage can occur from not striking the instrument at the appropriate angle due to incorrect height of the instrument. This invention allows even a child to adjust his or her cart without the use of mechanical devices such as wing nuts, snap buttons, telescoping legs, etc.
Function #2: There are no Orff instrument carts that have a tilting capability. This invention allows the instrument to be tilted, which is necessary when used by a wheelchair bound student.
Function #3: Wheelchair bound students are burdened with the task of reaching out beyond what is comfortable on all other Orff instrument carts. This new invention allows such a student to wheel themselves much closer to the playing surface of the instrument. With the added tilt adjustment, the student is at greater ease while playing.
Function #4: All teachers are burdened with the problem of not having enough space in their classroom. This new invention allows the teacher to stack and store the instruments when not needed. Many teachers do not even have their own classroom and are burdened with traveling from classroom to classroom throughout the day. This new invention allows the teacher to take everything that they would need from classroom to classroom.
Function #5: With the advent of technology, band directors have a plethora of electronic devices that aid them in teaching or conducting a band. It is difficult to have access to all of this equipment while at the conductor's podium. This new invention not only holds all of this equipment on one cart, but it allows the conductor to adjust the shelves and custom tailor the placement of these devices to suit their personal preferences.
Function #6: All other instrument carts do not have an area for related equipment. This new invention provides added space for such items.
Function #7: There are no xylophone carts that have an integrated sheet music holder on them. This new invention eliminates the need to set a separate music stand in front of the instrument.
Function #8: A problem with all other Orff instrument carts is the high center of gravity that exists with taller bass instruments. This new invention with its cantilever design, allows taller instruments to be placed lower on the cart which lowers the center of gravity and eliminates the chance of tipping the cart.
Function #9: On all other carts, clamping devices that secure the instrument, have a tendency to work themselves loose when rolling over rough surfaces. This new invention holds the instrument snugly to the carpeted surface with a strip of hook tape attached to the instrument and the instrument attached to the carpet.
Function #10: Misplaced or lost mallets are always a problem in a classroom of children. This invention provides a permanent place to store the mallets when the instruments are not is use.

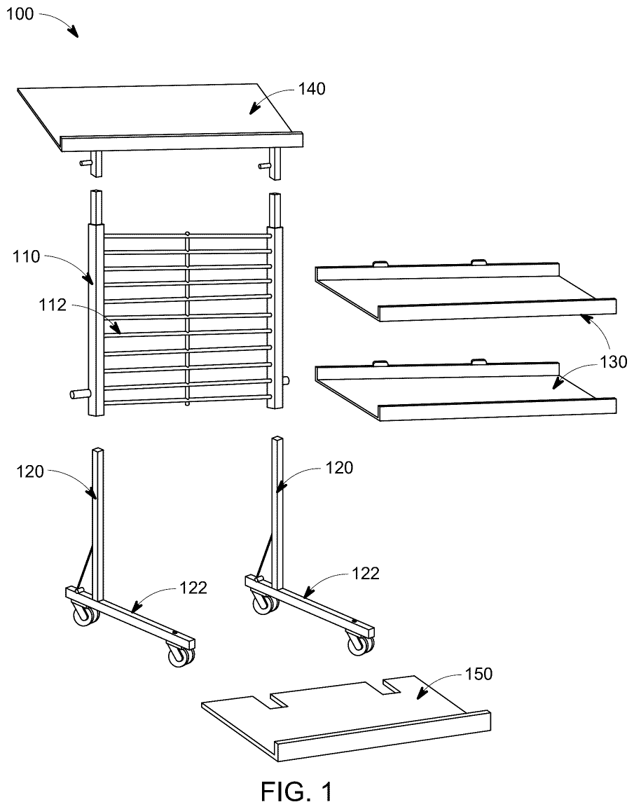

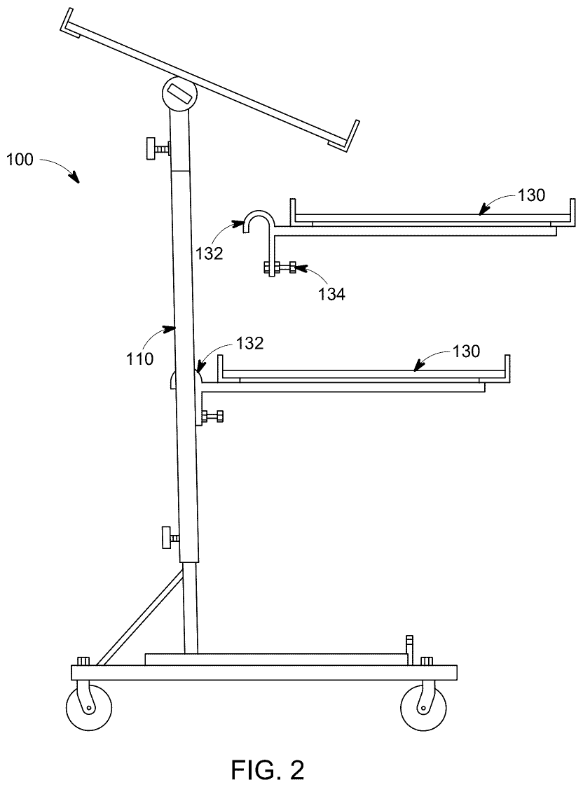

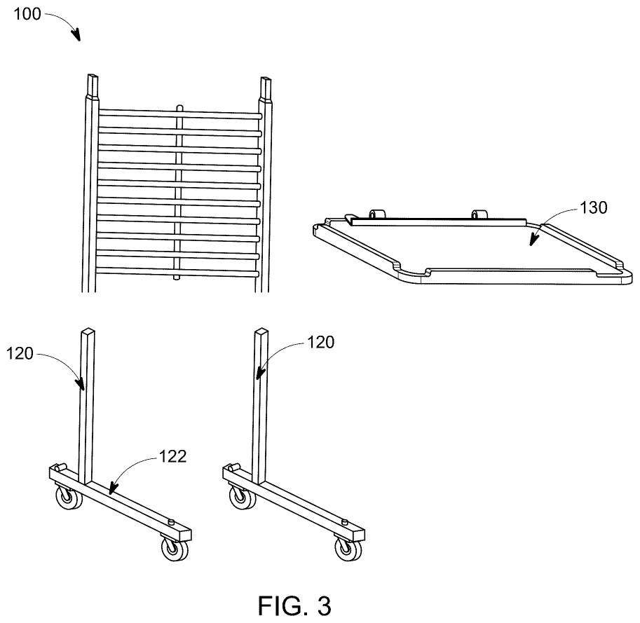

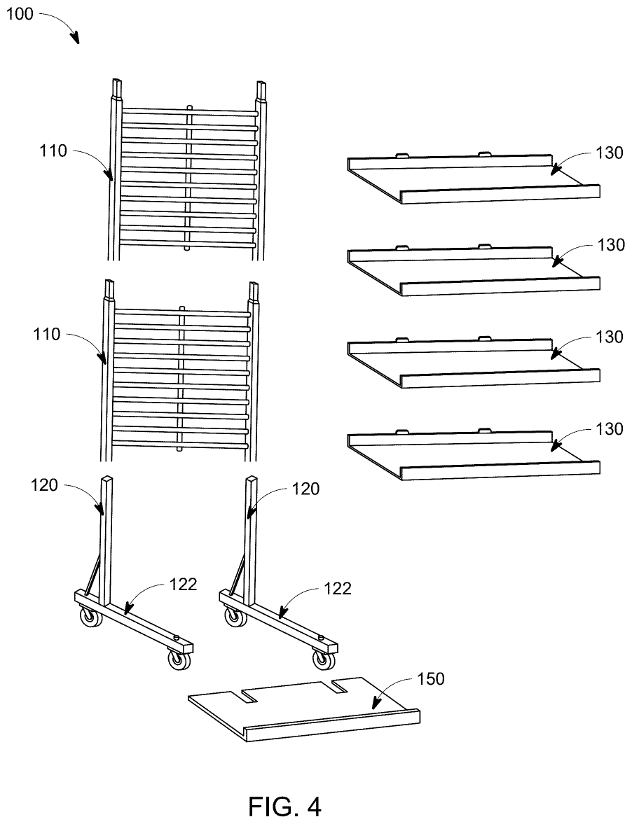

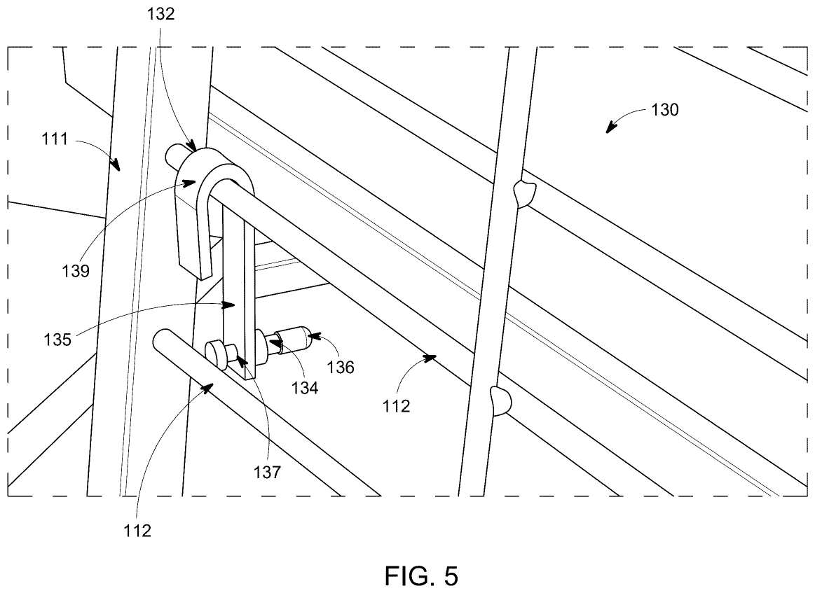

Referring now to the drawings FIGS. 1-7, the multifunctional xylophone/electronic piano cantilever cart 100 comprises a shelf support 110 including two parallel vertical posts 111 and a plurality of spaced horizontal rods 112 connected between the two parallel vertical posts; a pair of legs 120, each including a foot 122 extending perpendicularly outwards from its respective leg, wherein respective lower sections of the two parallel vertical posts of the shelf support are adapted to be respectively, releasably, and adjustably attach to upper sections of the pair of legs, such that the shelf support extends vertically therefrom; and at least one cantilever shelf 130 including a flat upper surface adapted to hold musical items thereon, and a pair of inverted hooks 132, each including a straight portion 135 including a first end that includes a threaded set screw hole 137 therethrough, and a second end spaced from the first end and including a curved portion 139 extending therefrom, and a threaded set screw 134 including a first end having a turning knob 136 adapted to allow a user to turn the threaded set screw and adjust the amount the threaded set screw protrudes from the set screw hole, and a second end adapted to contact any one of the plurality of spaced horizontal rods 112, wherein the threaded set screw is located within and rotatably engages with the threaded set screw hole, and wherein the threaded set screw extends perpendicularly from the straight portion. The inverted hooks 132 are spaced from one another and attached to an edge of the cantilever shelf 130 and are adapted to removably engage with two adjacent spaced horizontal rods 112, to thereby hold the cantilever shelf 130 in a predetermined orientation with respect to the shelf support 110.

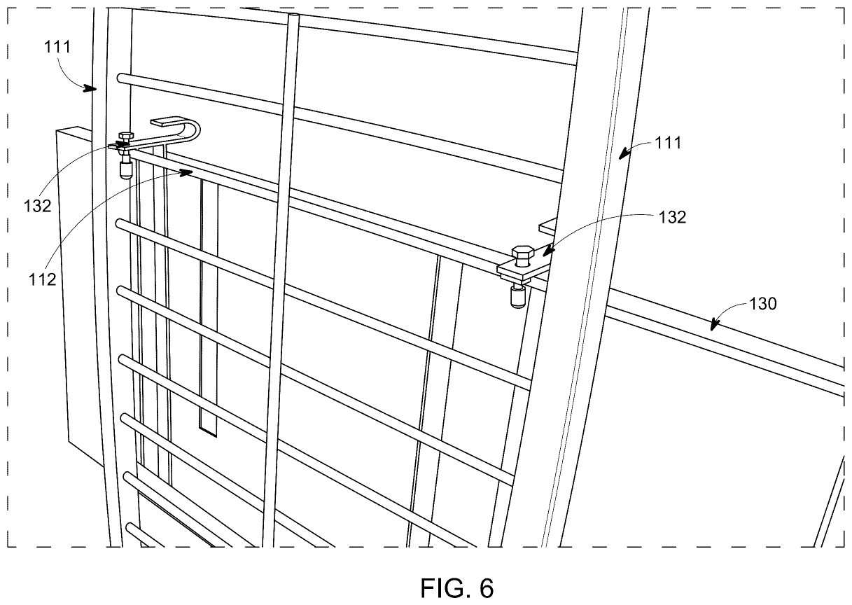

The threaded set screws 134 are adapted to be rotated and used to adjust the angle to which each of the cantilever shelves 130 extends from the shelf support 110. As shown in FIG. 6, the inverted hooks 132 are further adapted to allow each of the cantilever shelves 130 to be hung from one of the plurality of spaced horizontal rods 112 in a vertical orientation with respect to the shelf support 110. As such, another cantilever cart 100 can be placed and stored adjacent to the first, and so on.

In the preferred embodiment, the two parallel vertical posts 111 of the shelf support telescopically engage with the pair of legs 120. Furthermore, the cantilever cart 100 may further comprise at least one shelf support locking member 180 adapted to wrap around and selectively and releasably attach to at least one of the pair of legs 120 at a predetermined height to hold the shelf support at the height with respect to the pair of legs. Alternately, the support locking member 180 can be wrapped around at least one of the vertical posts 111 to hold the shelf support at the chosen height with respect to the pair of legs.

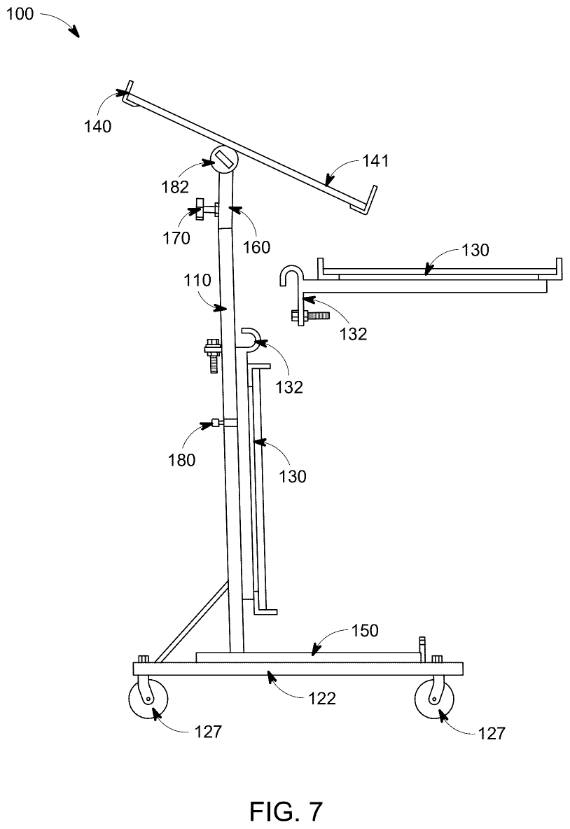

As shown in FIG. 7, the multifunctional xylophone/electronic piano cantilever cart may further comprise a sheet music holder 140 including two parallel vertical posts 160 adapted to releasably attach and be secured, via members 170, to respective upper sections of the two parallel vertical posts 111 of said shelf support 110; and an L-shaped platform 141 pivotally and adjustably connected, via friction members 182, to upper sections of the two parallel vertical posts 111, wherein the sheet music holder 140 extends vertically upwards from the shelf support 110 and is adapted to hold sheet music thereon.

In the preferred embodiment, one or multiple cantilever shelves 130 can be releasably connected to shelf support 110 depending on the needs of the user, and the heights of the shelf support 110 and the sheet music holder 140 adjusted as well.

In the preferred embodiment, each foot 122 of the pair of legs 120 includes two wheels 127 attached thereto adapted to allow the multifunctional xylophone/electronic piano cantilever cart to be mobile along a surface. Furthermore, the two parallel vertical posts 111 of the shelf support 110 and the pair of legs 120 are each formed from hollow tubing having a rectangular cross-section. Finally, in the preferred embodiment the multifunctional xylophone/electronic piano cantilever cart may further include a bottom shelf 150 adapted to be placed upon and across the feet 122 of the pair of legs 120 to hold more items thereon.

In one embodiment, the multifunctional xylophone/electronic piano cantilever cart 100 is used to hold an Orff xylophone or metallophone in a variety of positions. In another embodiment the multifunctional xylophone/electronic piano cantilever cart 100 can hold an electronic piano with a plurality of speakers, amplifiers and power packs. And, in another embodiment, shelf support 110 can be stacked to form a mobile instrument storage rack.

The embodiments of the invention described herein are exemplary and numerous modifications, variations and rearrangements can be readily envisioned to achieve substantially equivalent results, all of which are intended to be embraced within the spirit and scope of the invention. Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application.

Although specific embodiments have been illustrated and described herein, it will be appreciated by those of ordinary skill in the art that any arrangement, which is calculated to achieve the same purpose, may be substituted for the specific embodiment shown. This application is intended to cover any adaptations or variations of the present invention.

What is claimed is:

1. A multifunctional xylophone/electronic piano cantilever cart comprising:
a shelf support including:
two parallel vertical posts; and
a plurality of spaced horizontal rods;
wherein said plurality of spaced horizontal rods are connected between said two parallel vertical posts;
a pair of legs, each including:
a foot;
wherein said foot extends perpendicularly outwards from said leg;
wherein respective lower sections of said two parallel vertical posts of said shelf support are adapted to be respectively, releasably, and adjustably attach to upper sections of said pair of legs, such that said shelf support extends vertically therefrom; and
at least one cantilever shelf including:
a flat upper surface;
wherein said flat upper surface is adapted to hold musical items thereon; and
a pair of inverted hooks, each including:
a straight portion including:
a first end;
wherein said first end includes a threaded set screw hole therethrough; and
a second end;
wherein said second end is spaced from said first end;
a curved portion;
wherein said curved portion extends from said second end of said straight portion; and
a threaded set screw including:
a first end;
wherein said first end includes a turning knob adapted to allow a user to turn said threaded set screw and adjust the amount said threaded set screw protrudes from said set screw hole; and
a second end;
wherein said second end is adapted to contact any one of said plurality of spaced horizontal rods;
wherein said threaded set screw is located within and rotatably engages with said threaded set screw hole; and
wherein said threaded set screw extends perpendicularly from said straight portion;
wherein said inverted hooks are spaced from one another and attached to an edge of said cantilever shelf and are adapted to removably engage with two adjacent said plurality of spaced horizontal rods, to thereby hold said at least one cantilever shelf in a predetermined orientation with respect to said shelf support.

2. The multifunctional xylophone/electronic piano cantilever cart of claim 1, wherein said threaded set screws are adapted to be rotated and used to adjust the angle to which each of said at least one cantilever shelf extends from said shelf support.

3. The multifunctional xylophone/electronic piano cantilever cart of claim 1, wherein said inverted hooks are further adapted to allow each of said at least one cantilever shelf to be hung from one of said plurality of spaced horizontal rods in a vertical orientation with respect to said shelf support.

4. The multifunctional xylophone/electronic piano cantilever cart of claim 1, wherein said two parallel vertical posts of said shelf support telescopically engage with said pair of legs; and wherein said multifunctional xylophone/electronic piano cantilever cart further comprises at least one shelf support locking member adapted to wrap around and selectively and releasably attach to at least one of said pair of legs at a predetermined height to hold said shelf support at said height with respect to said pair of legs.

5. The multifunctional xylophone/electronic piano cantilever cart of claim 1, further comprising:
a sheet music holder including:
two parallel vertical posts;
wherein said two parallel vertical posts are adapted to releasably attach to respective upper sections of said two parallel vertical posts of said shelf support; and
an L-shaped platform;
wherein said L-shaped platform is pivotally and adjustably connected to upper sections of said two parallel vertical posts;
wherein said sheet music holder extends vertically upwards from said shelf support and is adapted to hold sheet music thereon.

6. The multifunctional xylophone/electronic piano cantilever cart of claim 1, wherein each foot of said pair of legs includes two wheels attached thereto adapted to allow said multifunctional xylophone/electronic piano cantilever cart to be mobile along a surface.

7. The multifunctional xylophone/electronic piano cantilever cart of claim 1, wherein said two parallel vertical posts of said shelf support and said pair of legs are each formed from hollow tubing.

8. The multifunctional xylophone/electronic piano cantilever cart of claim 7, wherein said hollow tubing is formed having a rectangular cross-section.

9. The multifunctional xylophone/electronic piano cantilever cart of claim 1, further comprising a bottom shelf adapted to be placed upon and across said feet of said pair of legs.
